(19) United States
(12) Patent Application Publication
(10) Pub. No.: US 2019/0214771 A1
(43) Pub. Date: Jul. 11, 2019

(54) Compliant Termination for a Controlled-Impedance Cable

(71) Applicant: Ardent Concepts, Inc., Hampton, NH (US)

(72) Inventors: Sergio Diaz, Cambridge, MA (US); Gordon A. Vinther, Hampton, NH (US); Joseph F. DiDonna, Lee, NH (US)

(21) Appl. No.: 16/127,836

(22) Filed: Sep. 11, 2018

Related U.S. Application Data
(60) Provisional application No. 62/557,110, filed on Sep. 11, 2017.
(60) Provisional application No. 62/651,467, filed on Apr. 2, 2018.

(51) Int. Cl. H01R 13/6471; H01R 13/6585; H01R 13/514; H01R 13/6474

(52) U.S. Cl. CPC H01R 13/6471; H01R 13/6474; H01R 13/514; H01R 13/6585

(57) ABSTRACT

An apparatus for terminating a controlled-impedance cable that employs compliant contact assemblies permanently attached to the cable signal conductors and, optionally, to the cable ground shield to provide a compliant interface between the cable and another electrical device. An anchor block has signal and ground through apertures to hold the signal and ground contacts that are permanently attached to the signal conductor and shield, either directly or by using a coupler. In one form, the coupler is a rectangular sheet that is crimped onto the signal conductor. In another form, the coupling has a generally S shape. The signal conductor extends through a hole at an angle and is captured. The contact is permanently attached to the coupling to form the contact assembly. For a twinaxial cable, two couplings are attached to the signal conductors and two more bridged couplings are attached to the two drain wires.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

### 1. Field of the Invention

The present invention relates to electrical cable terminations, more particularly, to controlled-impedance cable terminations which are generally used to transmit high-frequency signals between electronic devices.

### 2. Description of the Related Art

The purpose of a cable termination is to provide an interconnect between a cable and an electrical device, and to provide a separable electrical interconnection between the cable and its operating environment. The characteristic of separability means that the cables are not interconnected by permanent mechanical means, such as soldering or bonding, but by temporary mechanical means.

Currently, cables are terminated using a conventional-type connector that also has a controlled impedance, such as a male/female pair connectors that have one component soldered to the operating environment, for example, a printed circuit board (PCB), and one component soldered, crimped, or otherwise permanently fastened to the cable. In other cases, the connector or the cables are soldered to a different PCB that is then removably connected to the operating environment. The two PCBs are then attached with a compression interconnect interposer. While being generally the same impedance environment as the cable, there are impedance mismatches which cause high-frequency attenuation at the point of interface between the cable and the PCBs and between the connector and its working environment, such as like a PCB.

Additionally, these cable terminations often require through holes in PCBs for mounting and, consequently, it can be difficult to design the best possible controlled-impedance environment. These types of cable terminations have generally long transitions and thus introduce more signal reflections, which can inhibit higher frequency signals.

Another form of prior art is a system that uses two independent components to mate several cables to its operating environment. This system uses one component that is generally soldered to a PCB and another component that is generally mated to several cables. The two components can be plugged together to form the controlled-impedance interconnection. These systems are better-controlled impedance environments, but are limited by the signal integrity of the electrical path since the two mated components require a relatively long change in the transmission line that can cause reflections and limit bandwidth of the system.

Still another prior art system is a connector that terminates controlled-impedance cables to connectors using compliant “pins” to press into holes in a planar device such as a PCB. These holes generally need to be large, which can also limit bandwidth of the system.

### BRIEF SUMMARY OF THE INVENTION

The present invention is an apparatus and method for terminating a controlled-impedance cable. The cable terminator assembly employs compliant signal contact assemblies permanently attached to the cable signal conductors and optional compliant ground contact assemblies permanently attached to the cable ground shield to provide an interface between the cable and another electrical device. The terminator assembly is removably attached to the electrical device.

Configurations of the present invention employ a non-conductive anchor block that holds compliant signal contact assemblies for making the electrical connection between the signal conductor(s) and the electrical device, optional compliant ground contact assemblies for making the electrical connection between the cable shield and the ground plane of the electrical device, and ground sheet mounted to the anchor block.

The anchor block has a device face that abuts the electrical device and a cable face that abuts the signal conductors and drain wires. The ground sheet extends across the cable and shorts the drain wires together, and provides a surface to which the compliant ground contacts attached to form the ground contact assemblies. Signal through apertures that hold the signal contacts and optional ground through apertures that hold the optional ground contacts.

When installed, the signal contact assemblies are permanently attached to the signal conductors, as described below. The present invention contemplates a number of different methods of doing so. The optional compliant ground contact assemblies are permanently attached to the cable ground shield using the methods described below. Typically, the attachment is via drain wires.

Before the contact assemblies are permanently attached, the cable end is prepared by trimming back the sheath, shield, and dielectric to expose the signal conductor and drain wires.

There are several basic versions of the permanent attachment of the present invention. The contact cable end of the signal contact is permanently attached to the signal conductor of the cable by, for example, soldering or gluing. The contact cable end can be forked and attached, wedged against the anchor block, fit into a slot in the signal conductor, or crimped to the signal conductor.

Alternatively, a signal coupling is used between the signal conductor and the signal contact. The signal coupling is a separate component or the end of the signal contact is shaped to include the signal coupling. In either case, the signal coupling is considered by the present invention to be an element of the signal contact assembly.

One configuration of the signal coupling is a rectangular sheet that is crimped around the signal conductor. The signal contact is permanently attached to the coupling to form the signal contact assembly. The same coupling can be used on the drain wires.

The coupling can be extended to a twinaxial cable. Two of the couplings are crimped to the two signal conductors. Two more couplings are crimped to the two drain wires and are connected by a conductive bridge that bypasses the signal conductor couplings without making contact. Alternatively, an extension is crimped to the cable to keep the cable rigidly fixed relative to the couplings and/or to connect to the ground shield if there no drain wires.

Another configuration of the signal coupling has a generally S shape. The center section has a hole through which the signal conductor extends at an angle. The sharp edge of the hole digs into and grabs and retains the conductor. The end sections of the coupling extend generally parallel to the signal conductor. Optionally, the coupling has a cap that extends over the end of the signal conductor.

The coupling can be extended to a twinaxial cable. Two of the couplings are attached to the two signal conductors. Two more couplings are attached to the two drain wires and are connected by a conductive bridge that bypasses the signal conductor couplings without making contact. Alternatively, an extension is crimped to the cable to keep the cable rigidly fixed relative to the couplings and/or to connect to the ground shield if there no drain wires.

Objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is a perspective view of one embodiment of the termination of the present invention;

FIG. 2 is an exploded, perspective view of the embodiment of FIG. 1;

FIG. 3 is a perspective view of one embodiment of the termination of the present invention;

FIG. 4 is an exploded, perspective view of the embodiment of FIG. 3;

FIG. 5 is a perspective view of a basic permanent attachment of the contact to the signal conductor;

FIG. 6 is a perspective view of a fork-shaped contact cable end for permanent attachment to the signal conductor;

FIG. 7 is a perspective view of another fork-shaped contact cable end for permanent attachment to the signal conductor;

FIG. 8 is a perspective view of a wedged contact cable end for permanent attachment to the signal conductor;

FIG. 9 is a perspective view of a slotted signal conductor for permanent attachment to the contact cable end;

FIG. 10 is a perspective view of a crimp contact cable end for permanent attachment to the signal conductor;

FIG. 11 is a perspective view of a basic permanent attachment of the contact to the signal conductor with a signal coupling;

FIG. 12 is a perspective view of another coupling installed on a signal conductor;

FIG. 13 is a perspective view of a signal contact assembly composed of a coupling and a signal contact installed on a signal conductor;

FIG. 14 is a perspective view of a signal contact assembly as a unitary component;

FIG. 15 is a side view of the coupling installed on a signal conductor identifying important surfaces;

FIG. 16 is a perspective view of a coupling with a solder hole installed on a signal conductor;

FIG. 17 is a perspective view of a coupling installed on a shaped signal conductor;

FIG. 18 is an unassembled, perspective view of the coupling of FIG. 12 extended to a twinaxial cable;

FIG. 19 is a perspective view of the coupling of FIG. 17 installed on a twinaxial cable with drain wires;

FIG. 20 is a perspective view of the coupling of FIG. 18 installed on a twinaxial cable without drain wires;

FIG. 21 is a perspective view of the coupling of FIG. 18 installed on a twinaxial cable with compliant contacts;

FIG. 22 is a perspective view of the coupling of FIG. 18 installed on a twinaxial cable showing the attachment location of the compliant contacts;

FIG. 23 is a perspective view of the coupling of FIG. 18 with solder holes installed on a twinaxial cable with compliant contacts;

FIG. 24 is a perspective view of the coupling of FIG. 18 installed on a twinaxial cable and identifying important parameters;

FIG. 25 is a perspective view of the coupling of FIG. 18 installed on a twinaxial cable with drain wires with compliant contacts and a clamp over the cable;

FIG. 26 is a perspective view of a coupling of FIG. 12 installed on a signal conductor with a configuration of a spring finger;

FIG. 27 is an exploded perspective view of a coupling of FIG. 12 for installation on a signal conductor with another configuration of a spring finger;

FIG. 28 is a side, cross-sectional view of the coupling of FIG. 27 installed on a signal conductor in the uncompressed state;

FIG. 29 is a side, cross-sectional view of the coupling of FIG. 27 installed on a signal conductor in the compressed state;

FIG. 30 is a perspective view of another coupling installed on a signal conductor;

FIG. 31 is a partial phantom, side view of the coupling of FIG. 30 installed on a signal conductor;

FIG. 32 is a perspective view of the coupling of FIG. 30 installed on a signal conductor with a solder filet;

FIG. 33 is a perspective view of the coupling of FIG. 30 installed on a signal conductor with an attached compliant contact;

FIG. 34 is a perspective view of the coupling of FIG. 30 with an end cap installed on a signal conductor;

FIG. 35 is a perspective view of the coupling of FIG. 30 with an end cap installed on a signal conductor with an attached compliant contact;

FIG. 36 is a perspective view of the coupling of FIG. 30 with an end cap as the end of the compliant contact installed on a signal conductor;

FIG. 37 is an exploded, perspective view of the coupling of FIG. 34 extended to a twinaxial cable;

FIG. 38 is a perspective view of the coupling of FIG. 34 installed on a twinaxial cable with drain wires;

FIG. 39 is a perspective view of the coupling of FIG. 34 installed on a twinaxial cable with attached compliant contacts;

FIG. 40 is a front, perspective view of the coupling of FIG. 34 installed on a twinaxial cable without drain wires with attached compliant contacts;

FIG. 41 is a back, perspective view of the coupling of FIG. 34 installed on a twinaxial cable without drain wires with attached compliant contacts; and

FIG. 42 is a perspective view of a plurality the assembly of FIG. 40 arranged in a matrix.

### DETAILED DESCRIPTION OF THE INVENTION

The present application hereby incorporates by reference in their entirety U.S. Provisional Patent Application Nos. 62/557,110 and 62/651,467, on which this application is based.

The present invention is an apparatus and method for terminating a controlled-impedance cable 20 with a compliant contact assembly 30 that can mate directly with an electrical device wherein the compliant signal contact assembly 30 is permanently attached to the signal conductor 22 of the controlled-impedance cable 20 and, optionally, the compliant ground contact assembly(s) 31 is permanently attached to the ground shield 26 of the controlled-impedance cable 20.

The connector terminator 10 of the present invention is for use with a controlled-impedance cable 20 with one or more signal conductors 22, each surrounded by a dielectric 24, and with a ground shield 26 outside the dielectric. The term “ground shield” is used in a general way and can refer to conductive metalized wrap, foil, woven wire wraps, and/or drain wires 27. Optionally, a sheath 28 covers the shield 26. The term, “cable”, in the present specification refers to a controlled-impedance cable.

The present invention includes a cable terminator 10 that employs compliant signal contact assemblies 30a-b (collectively, 30) and optional compliant ground contact assemblies 31a-f (collectively, 31) to provide an interface between the controlled-impedance cable 20 and another electrical device. As described in more detail below, the compliant signal contact assembly 30 is comprised of a compliant signal contact 32 and, optionally, a signal coupling 38 that are permanently attached together, and the optional compliant ground contact assembly 31 is comprised of a compliant ground contact 33 and, optionally, a ground coupling 39 that are permanently attached together.

The terminator assembly 10 is removably attached to the electrical device by a compression force in a direction of compression 4 that can be provided by mechanical fasteners such as screws, latches, or leaf spring levers. These fasteners can thread or attach to a frame or one or more posts surface-mounted to the electrical device. The compliant contact assemblies 30, 31 compensate for non-coplanarities between the conduction points of the electrical device such as a PCB or integrated circuit substrate.

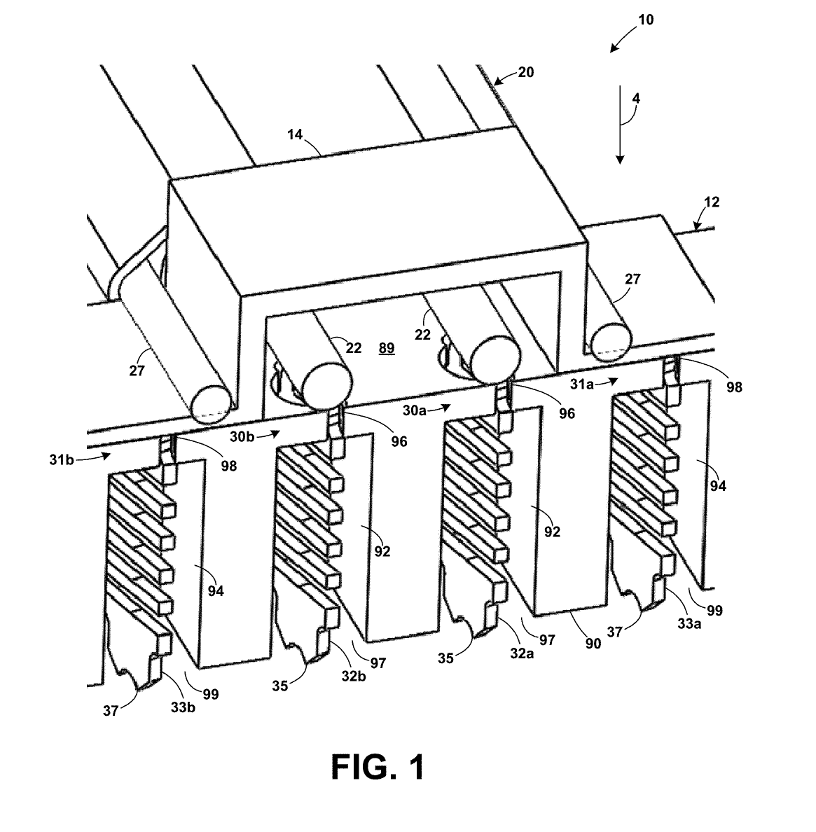

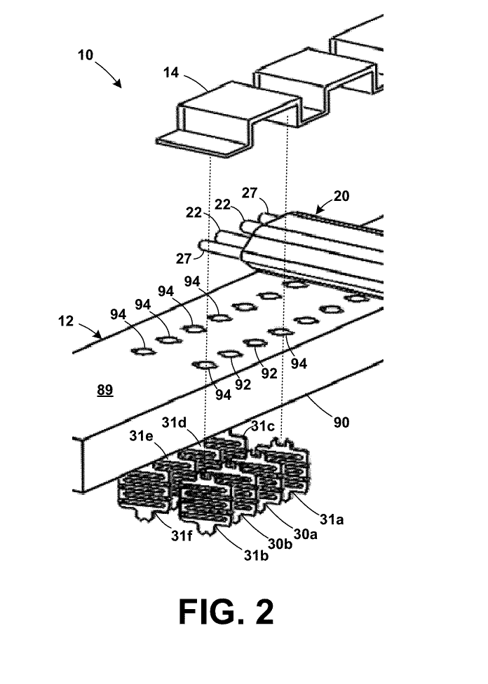

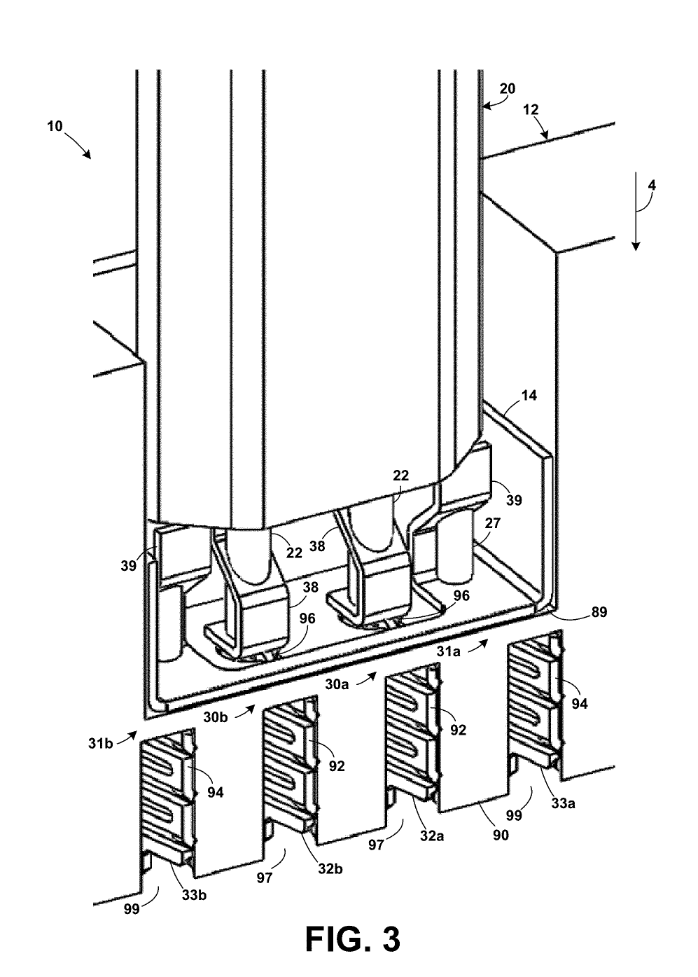

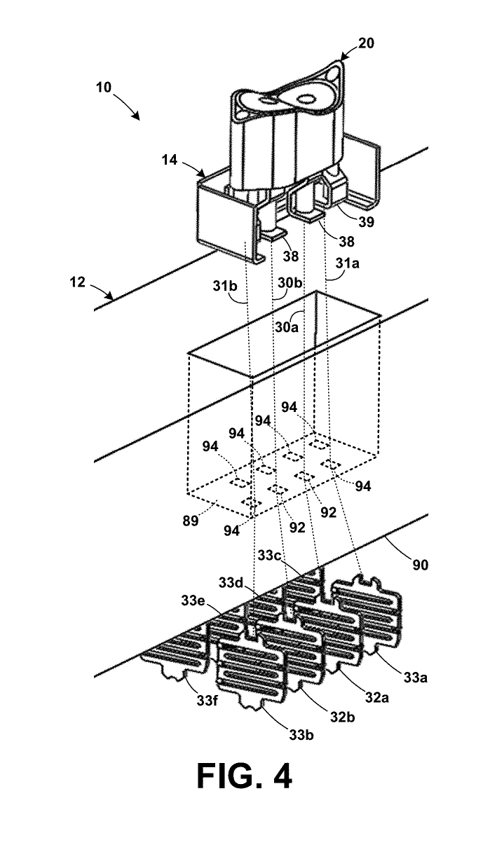

Configurations of two embodiments of the present invention are shown in FIGS. 1-4. They employ an anchor block 12, compliant signal contact assemblies 30a, 30b for making the electrical connection between the signal conductor(s) 22 and the electrical device, optional compliant ground contact assemblies 31a-f for making the electrical connection between the cable shield 26 and the ground plane of the electrical device, and a ground sheet 14 mounted to the anchor block 12.

The anchor block 12 is composed of a nonconductive material and holds the compliant contact assemblies 30, 31. The anchor block 12 has a device face 90 that abuts the electrical device and a cable face 89 that abuts the signal conductors 22 and ground shield 26 (via drain wires 27) of the cables 20. The conductive ground sheet 14 extends across the cable 20 and shorts the drain wires 27 together as well as provides a surface with which the compliant ground contacts 33 make electrical connection to the ground shield 26 to form the ground contact assemblies 31. The ground sheet 14 should be shaped so as to preserve the desired impedance environment around the signal contact assemblies 30a, 30b after the cable 20 has been permanently attached. The ground sheet 14 is attached to the anchor block 12 by whatever means is adequate, such as by screws, rivets, or adhesive.

The anchor block 12 has signal through apertures 92 that hold the signal contacts 32. Each signal through aperture 92 has a cable face signal opening 96 and a device face signal opening 97. When installed in the signal through apertures 92, the contact cable end 34 of the signal contact 32 extends from the cable face signal opening 96 and the device end 35 extends from the device face signal opening 97.

The anchor block 12 has optional ground through apertures 94 that hold the optional ground contacts 32.

Each ground through aperture 94 has a cable face ground opening 98 and a device face ground opening 99. When installed in the aperture 94, the cable end 36 of the ground contact 33 extends from the cable face ground opening 98 and the device end 37 of the ground contact 33 extends from the device face ground opening 99.

The cable face signal openings 96 of the signal apertures 92 are aligned with the locations of the corresponding signal conductors 22. When installed, the signal contact assemblies 30 are permanently attached to the signal conductors 22, as described below.

The cable face ground openings 98 of the ground apertures 94 are aligned with the ground plane 14. In the illustrated configuration, there are six ground contact assemblies 31a-f, one each 31a, 31b bracketing the two signal contact assemblies 30a, 30b and four 31c-f in a row outside of the signal contact assemblies 30. This particular arrangement closely preserves the desired controlled-impedance environment.

Once the cable(s) 20 are attached to the anchor block 12 and the signal conductors 22 are attached to the signal contact assemblies 30, the assembly 10 can be used to terminate the cable(s) 20 to an electrical device such as a PCB or an integrated circuit substrate without the need for holes to attach. The present invention can be terminated to the electrical device with a compressive force in the direction of compression 4 to conductive pads on the electrical device.

A criteria for a compliant contact for use in the present invention is that it can impart a biasing force to an electrical device strong enough to maintain good contact throughout the life of the connector while maintaining the characteristic impedance of the cable and planar electrical device.

Example compliant contacts for use with the present invention include spring probes, stamped metal contacts, chemically etched contacts, wound wire contacts including skewed coil contacts. The etched or stamped contact is a strip of conductive material formed in such a way as to create a spring member which adds compliance on one end of the contact and provides for a rigid attachment to the signal conductor on the other end of the contact. Compliance can be accomplished with different contact types such as in a C shape contact or a cantilever member that is captured in an aperture that fixes the end of the contact that is to be rigidly connected to the conductor and allows the other end of the contact to deflect so that the contact can apply a biasing force which can be used to make a temporary interconnect with a planar device.

The present invention may also be used with compliant contacts that are manufactured by adding compliant members to a PCB that use thru vias to carry signals from one side of the PCB to the other.

The compliant signal contact assembly 30 is permanently attached to the signal conductor 22. The present invention contemplates a number of different methods of doing so.

Where appropriate, the compliant ground contact assembly 31 is permanently attached to the cable ground shield 26 using the methods described below. Typically, the attachment is via a drain wire 27.

Before the contact assemblies 30, 31 can be permanently attached, the end of the cable 20 is prepared by trimming back the sheath 28, shield 26, and dielectric 24 to expose the signal conductor 22 (and drain wires 27, where appropriate). The exposed signal conductor 22 is permanently attached to one end of the signal contact assembly 30.

As it relates to the present invention, the phrase, “permanently attached,” means that the attachment is not intended to be separable, that is, is cannot be separated non-destructively. Example attachments include, but are not limited to, crimping, soldering, gluing, welding, and coining the contact to the signal conductor or drain wire.

The current invention also contemplates performing an optional secondary operation on the signal conductor 22 prior to permanently attaching the signal contact assembly 30 to make it more suitable for attaching the signal contact 30. For example, the end of the signal conductor 22 may be coined or forged into such a particular shape to accept and hold onto a feature of the signal contact assembly 30, or to better accept and hold adhesive or solder.

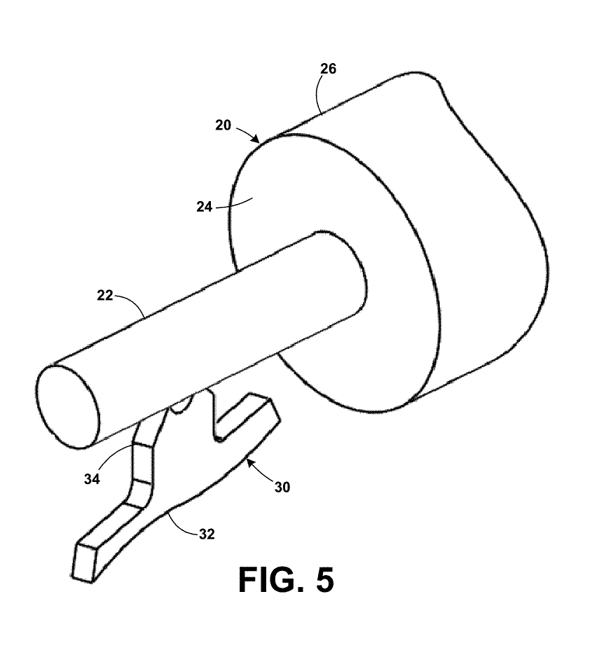

FIG. 5 shows a basic version of the permanent attachment of the present invention. The contact cable end 34 of the signal contact 32 is permanently attached to the signal conductor 22 of the cable 20 using an appropriate method. Examples of such method include soldering and gluing with a conductive or non-conductive adhesive.

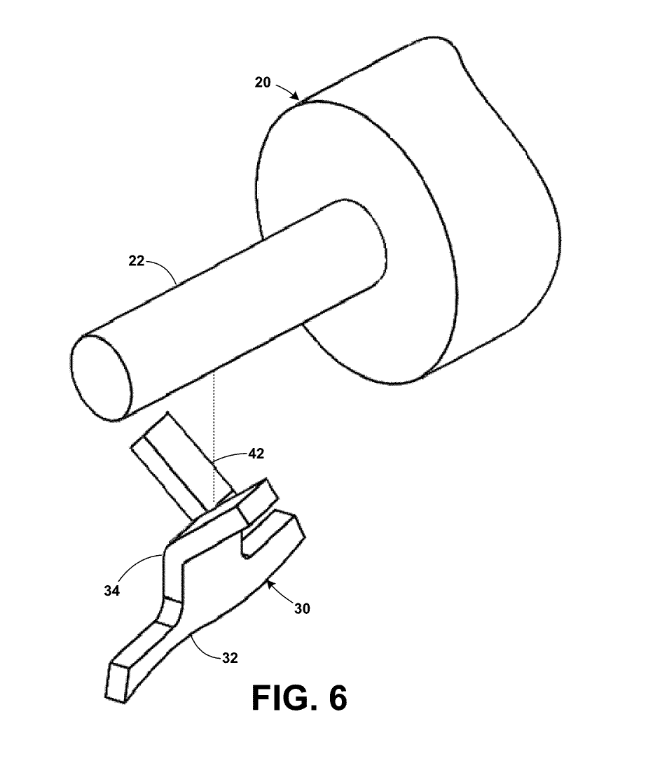

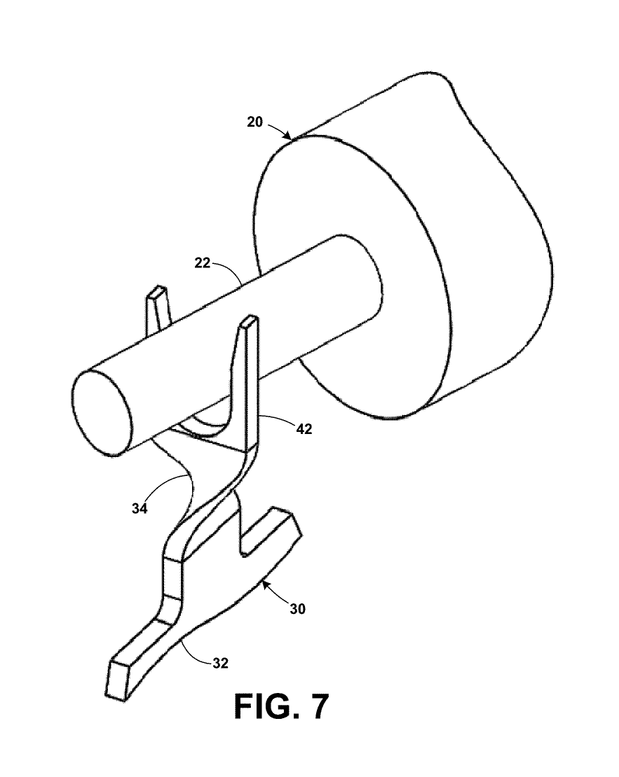

FIGS. 6 and 7 shows the contact cable end 34 configured with two different forked ends 42. The forked end 42 is permanently affixed to the signal conductor 22 using an appropriate method, such as the examples listed above.

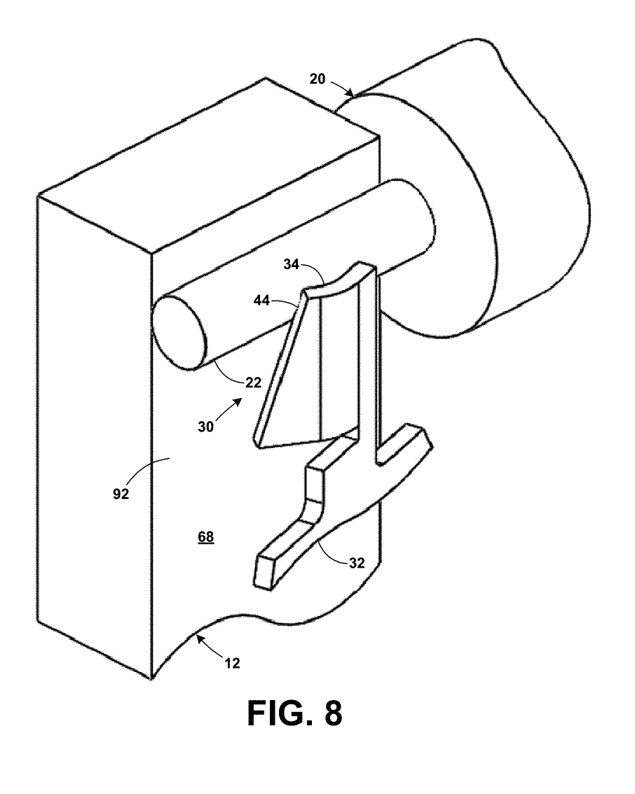

FIG. 8 shows the signal conductor 22 wedged between a sharp edge 44 on the contact cable end 34 and the anchor block 12. The contact cable end 34 is affixed in the signal contact aperture 92 in some manner. As the signal conductor 22 is inserted downwardly from the top, the sharp edge 44 on the contact cable end 34 pushes the signal conductor 22 sideways against the vertical wall 68 of the anchor block 12. Neither the contact cable end 34 nor the anchor wall 68 yield, forcing the sharp edge 44 to slice into the signal conductor 22. A vertical stop can be incorporated in the contact cable end 34 or in the anchor wall 68 to prevent the sharp edge 44 from cutting all the way through the signal conductor 22. Once the signal conductor 22 is wedged, it cannot be pulled out along its longitudinal axis due to shear forces acting on the signal conductor 22.

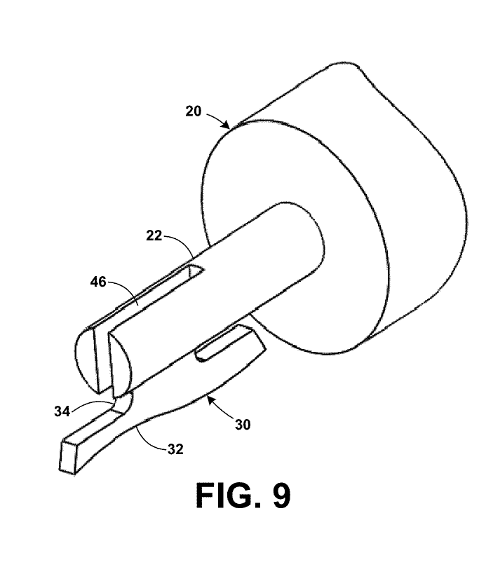

In FIG. 9, a longitudinal slot 46 is cut into the end of the signal conductor 22. The contact cable end 34 is inserted into the slot 46 and secured. The securement can take any appropriate form, including press-fit, solder, and adhesive. This attachment can be formed at a 90° angle, as shown in FIG. 9, or with the signal contact assembly 30 longitudinally-aligned with the signal conductor 22.

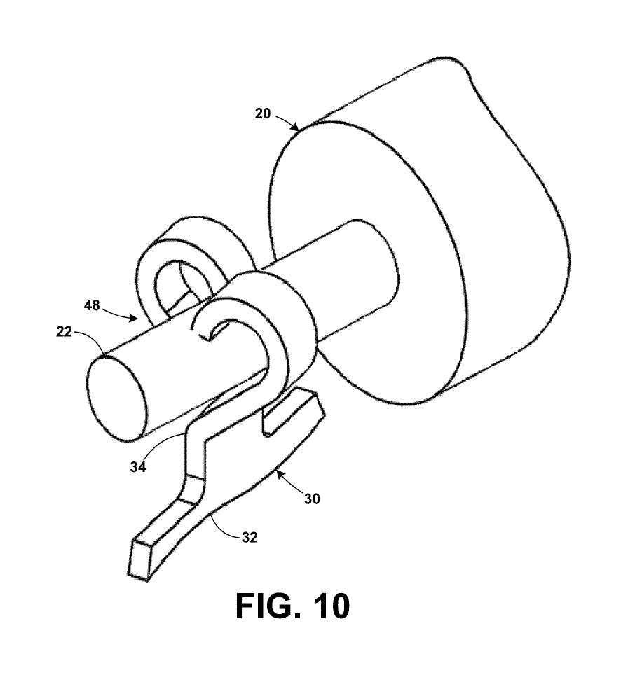

FIG. 10 shows the contact cable end 34 crimped around the signal conductor 22, as at 48.

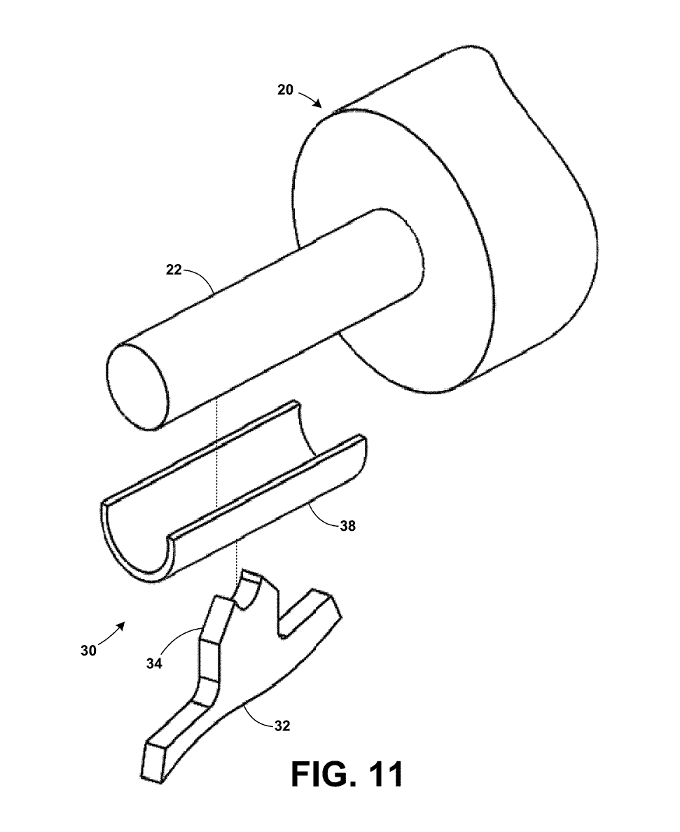

FIG. 11 shows a simple solder or conductive adhesive signal coupling 38 between the contact cable end 34 and the signal conductor 22. The signal coupling 38 can take any appropriate shape and can be used in conjunction with all other forms of permanent attachment described herein. The signal coupling 38 can be a separate component. Alternatively, the end of the signal contact 32 is shaped to include the signal coupling 38. In either case, the signal coupling 38 is considered by the present invention to be an element of the signal contact assembly 30.

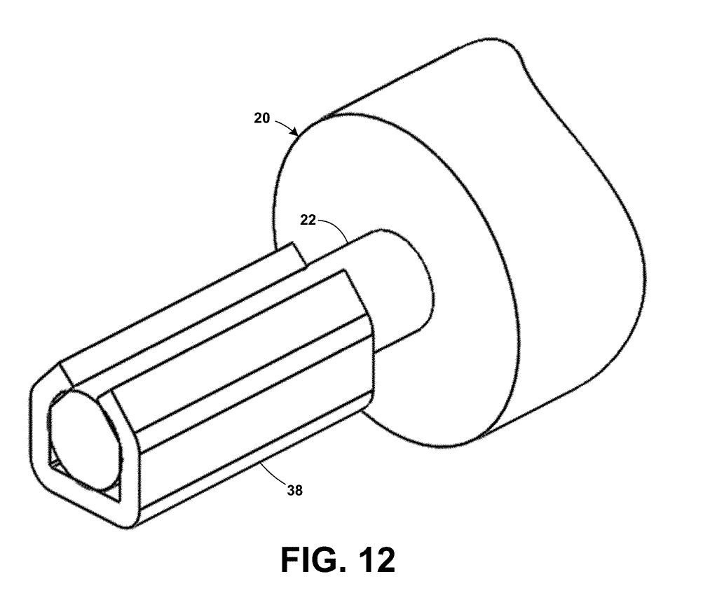

FIGS. 12-25 show various configurations of an signal coupling 38 crimped around the signal conductor 22. The signal contact 32 is then permanently attached to the signal coupling 38 to form the signal contact assembly 30. A ground coupling 39 of the same structure can be crimped around the drain wire 27 and the ground contact 33 permanently attached to the ground coupling 39 to form the ground contact assembly 31.

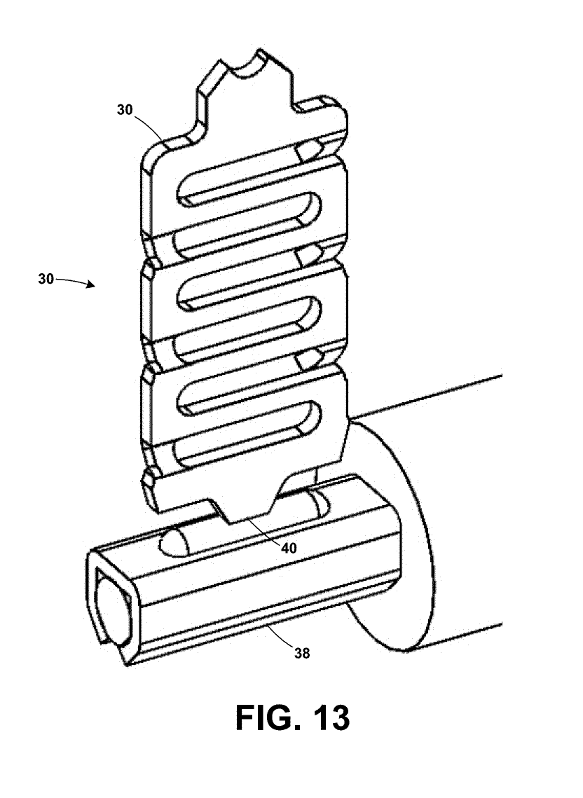

FIG. 12 shows the coupling 38 crimped around the signal conductor 22. The coupling 38 is a rectangular sheet of a conductive material, typically a material used in electrical contacts, that is bent around and crimped to the signal conductor 22. The signal contact 32 is then permanently attached to the coupling 38, as at 40 in FIG. 13, to form the signal contact assembly 30.

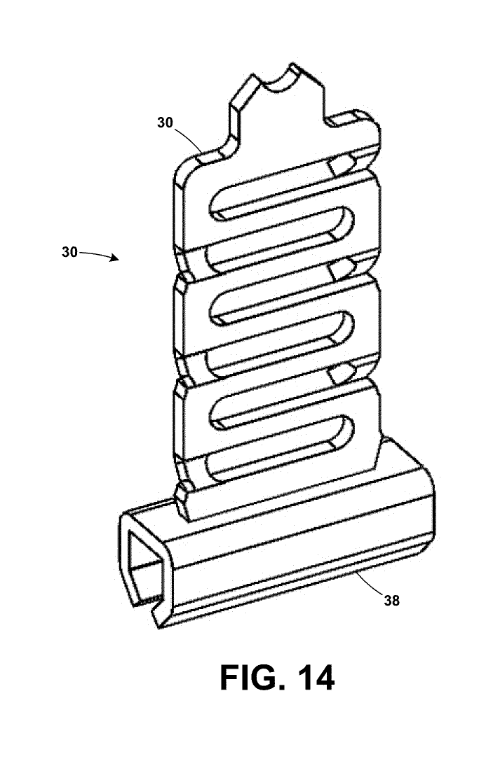

Alternatively, the coupling 38 is formed as one end of the signal contact 32, as in FIG. 14. The coupling 38 is bent around and crimped to the signal conductor 22.

Both configurations of the coupling/contact, the separate components of FIG. 13 and the integral component of FIG. 14, are contemplated by the present invention. In either case, the coupling 38 is considered by the present invention to be an element of the signal contact assembly 30.

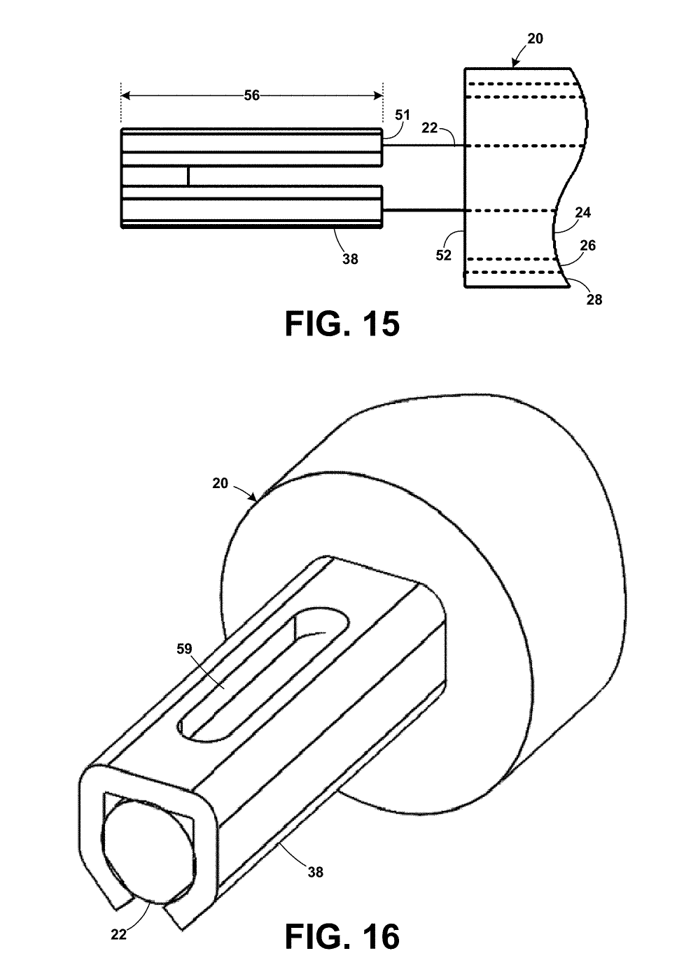

FIG. 15 indicates an important surface of the coupling 38, the end 51 of the coupling 38 closest to the cable dielectric 24, and an important surface 52 of the cable 20, the exposed end 52 of the trimmed-back dielectric 24. The relative positions of these surfaces 52, 54 and the length 56 of the coupling 38 control the phase length of the assembly as well as how much of the coupling 38 will need to extend past the contact cable end 34. The coupling 38 needs to be long enough to provide a large enough land for the signal contact 32 to attach, but short enough not to radiate. The present invention recognizes the need to precisely control cable length, trim, and coupling position on the signal conductor 22 for optimal phase length and impedance control.

In FIG. 16, the coupling 38 has a hole 59 for soldering or adhesive. After the contact cable end 34 is in electrical contact with the signal conductor 22, solder or adhesive is added in the hole 59 to facilitate bonding between the contact cable end 34 and the signal conductor 22.

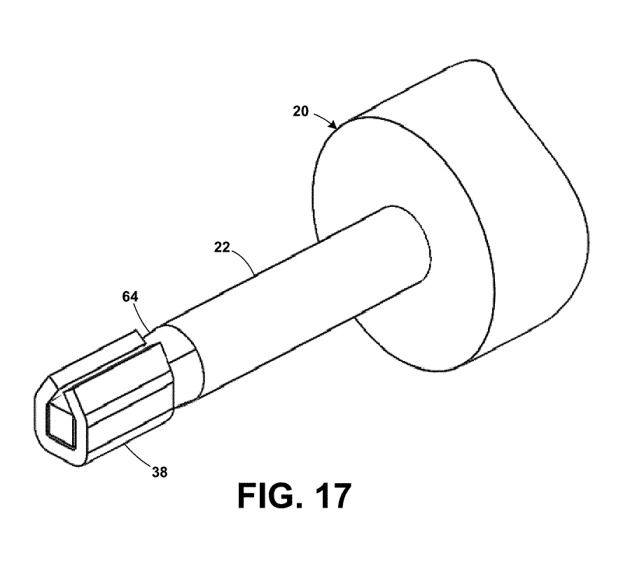

In FIG. 17, the signal conductor 22 is shaped, as at 64, prior to crimping the coupling 38 onto the signal conductor 22. The shaping helps to maintain the general size of the signal conductor 22 cross-section after the coupling 38 is attached. Another benefit of shaping is to remove any coatings or platings in order to facilitate a more effective soldering or bonding. The shaping can be done by, for example, forging, stamping, coining, drawing, or shaving. The shaping can be performed with external tooling, or by the coupling 38 itself as it collapses around the signal conductor 22.

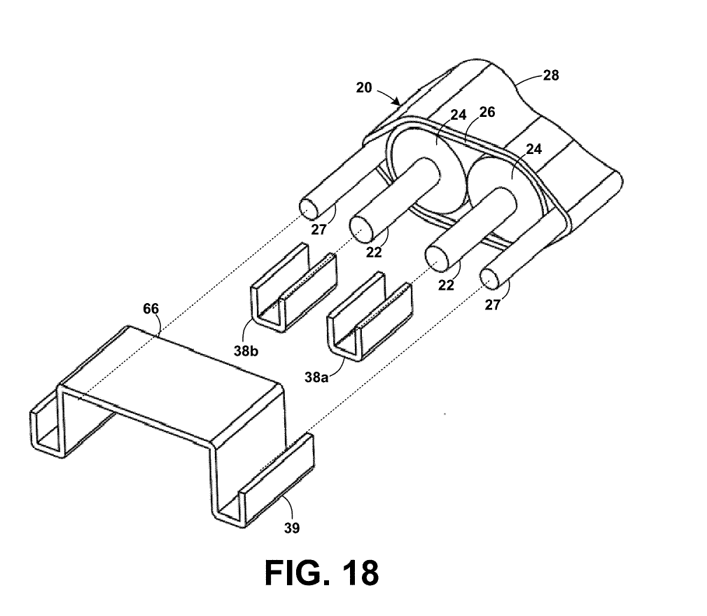

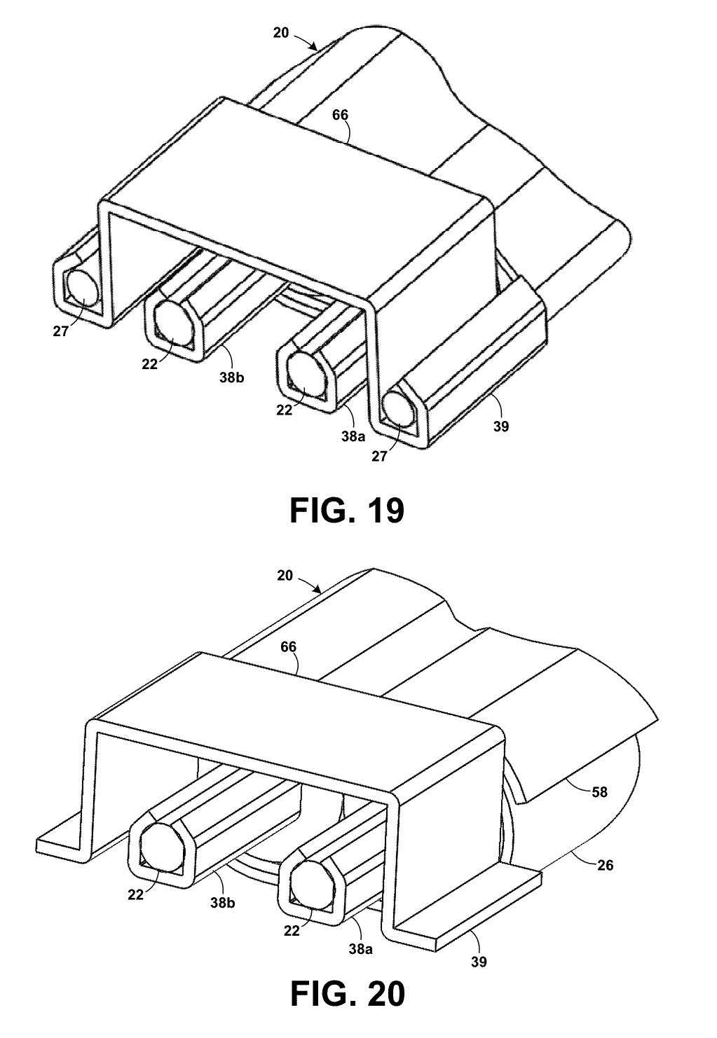

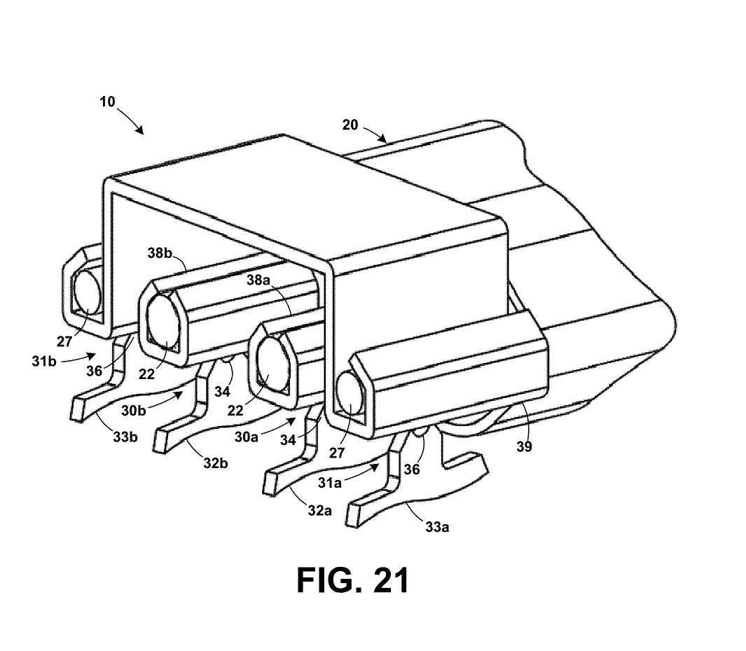

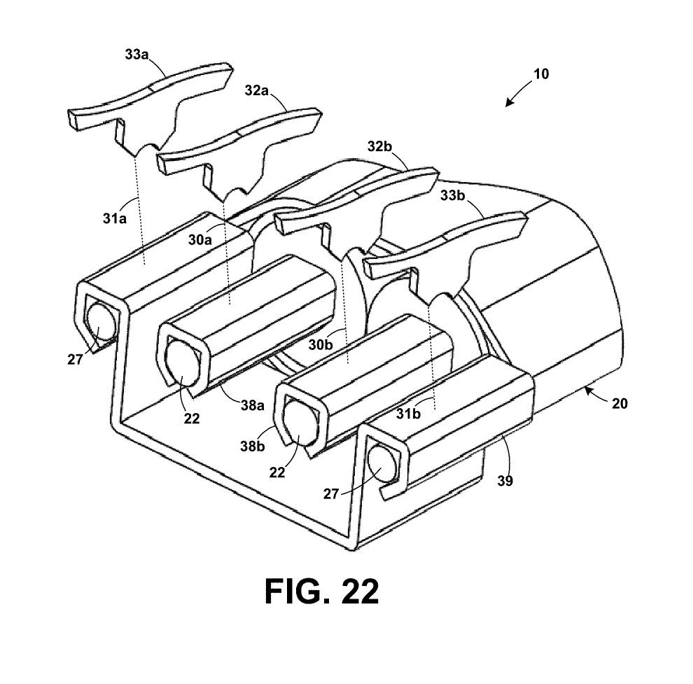

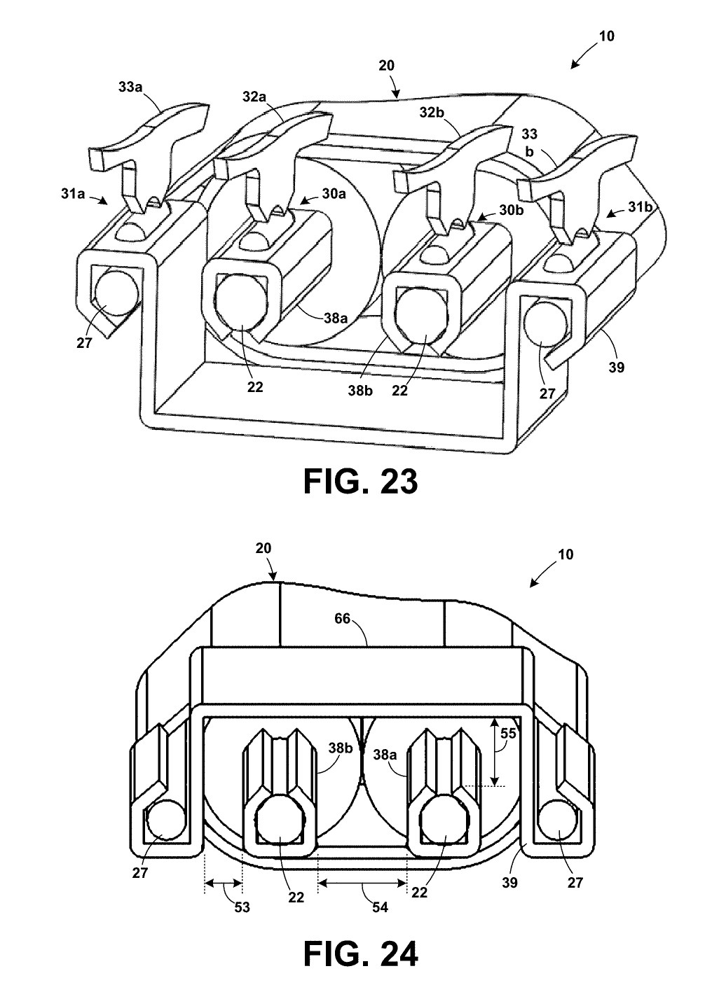

FIGS. 18-25 show the coupling 38 of FIG. 12 extended to a twinaxial cable. FIG. 18 is an unassembled view showing three couplings 38a, 38b 39 and the trimmed end of a twinaxial cable 20. Two of the couplings 38a, 38b are the signal couplings 38 of FIG. 12 and are for the two signal conductors 22. The third coupling 39 is the ground coupling for attaching to the cable shield 26 via the drain wires 27. The ground coupling 39 is essentially two single couplings attached by a conductive bridge 66 that bypasses the signal conductor couplings 38a, 38b without making contact with the signal couplings 38a, 38b. FIG. 19 shows the couplings 38a, 38b crimped to the signal conductors 22 and the bridged ground coupling 39 crimped to the drain wires 27. FIG. 20 shows the couplings 38a, 38b crimped to the signal conductors 22 and a bridged ground coupling 39 clamped to the cable shield 26 without drain wires 27, as at 58. FIG. 21 shows the assembly with signal contact cable ends 34 attached to the couplings 38a, 38b to form the signal contact assemblies 30a, 30b, and ground contact cable ends 36 attached to the bridged ground coupling 39 to form the signal contact assemblies 31a, 31b. The contact cable ends 34, 36 are perpendicular to the signal conductors 22 and drain wires 56. FIGS. 22 and 23 show the locations on the couplings 38a, 38b, 39 where the cable ends 34, 36 are attached. Those locations can be flat, plated lands, as in FIG. 22, or they can be holes 56 in the couplings 38a, 38b, 39 filled with solder or adhesive, as in FIG. 23, to facilitate bonding.

FIG. 24 shows several of the parameters critical to maintaining the impedance environment of the termination: the distance 53 between the ground coupling 39 and the nearest signal coupling 38a, 38b, the distance 54 between the signal couplings 38a, 38b, and the distance 55 between the signal couplings 38a, 38b and the ground coupling bridge 66. The dielectric constant of the material filling the volume around the signal conductors 22 is also critical, whether it is air or some other material. It is recognized that careful tuning of the physical distances 53, 54, 55 and the properties of the filler material with tools such as electromagnetic modeling software is necessary to achieve the desired impedance environment.

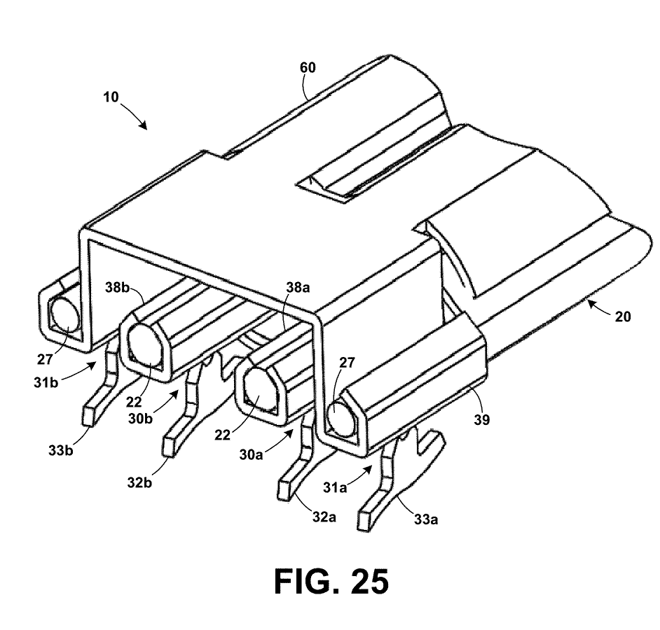

FIG. 25 shows the assembly of FIG. 19 with the ground coupling extended, as at 60, to overlap the twinaxial cable shield 26. The extension 60 is crimped to the cable 20 to keep the cable 20 rigidly fixed relative to the couplings 38a, 38b, 39.

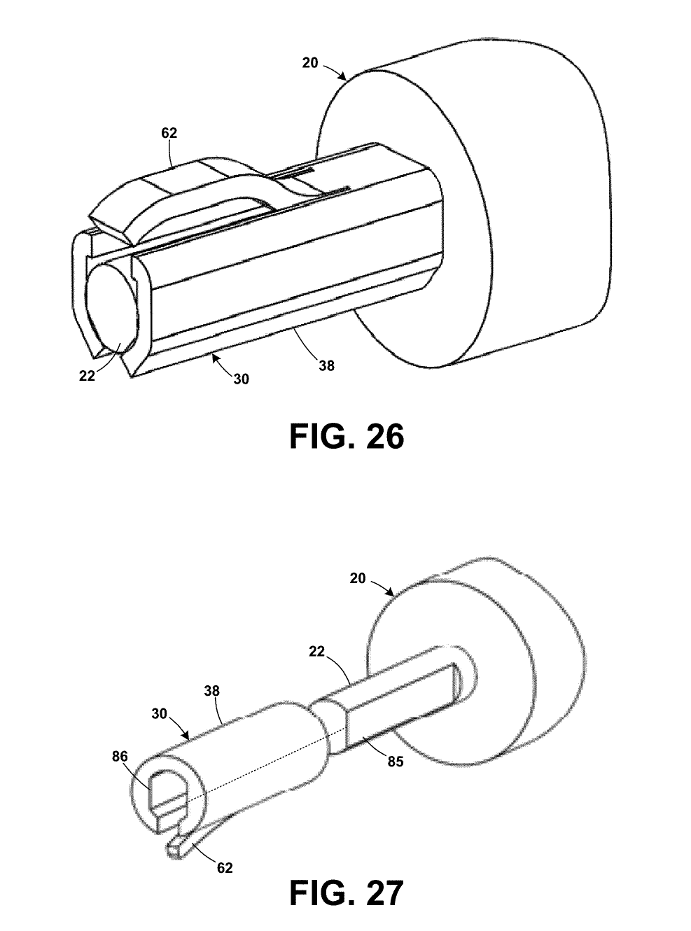

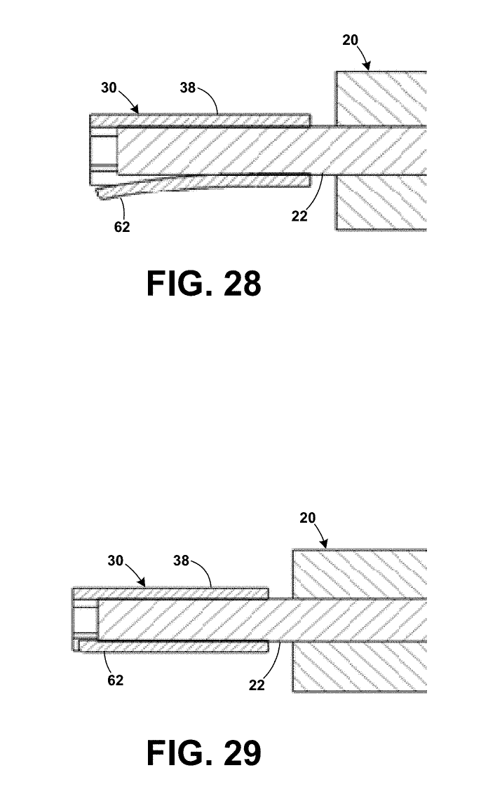

FIGS. 26-29 show the crimped coupling 38 of FIG. 12 with a spring finger 62 to form the signal contact assembly 30. When the coupling 38 is produced, additional cuts are made so that a strip can be bent away from the signal conductor 22 to bias outwardly. In FIG. 26, the finger 62 has a C shape. In the exploded view of FIGS. 27, the coupling 38 is round and the finger 62 is bent away in the uncompressed state, but remains straight, as can be seen in FIG. 28. Optionally, the signal conductor 22 and the coupling 38 are made with flats 85, 86 to orient the coupling 38, as in FIG. 27. The finger 62 provides additional compliance.

When the finger 62 is compressed against the electrical device, the finger 62 deflects until the coupling 38 forms a non-interrupted cylinder, as in FIG. 29. The property of non-interruption brings the coupling 38 into an optimal shape for impedance control.

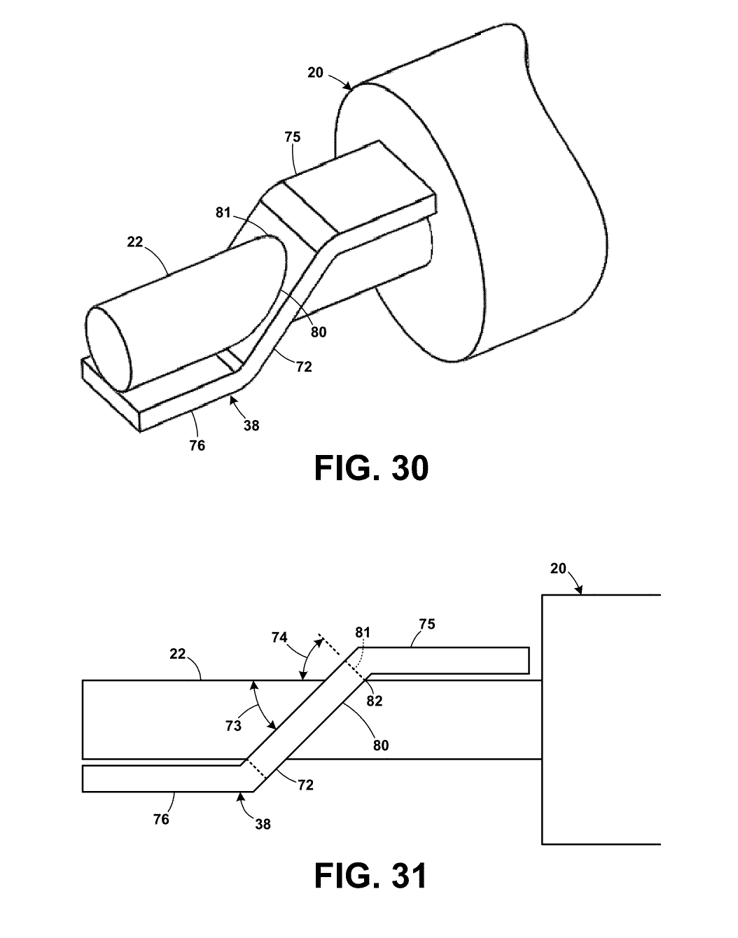

FIGS. 30-41 show various configurations of another coupling 38 permanently attached to the signal conductor 22 to which the contact cable end 34 is permanently attached. FIG. 30 shows the coupling 38 attached to the signal conductor 22. The coupling 38 has a generally S shape. The center section 72 has a hole 80 through which the signal conductor 22 extends. When installed on the signal conductor 22, the center section 72 is at an angle 73 to the signal conductor 22 that is not 90°, as in FIG. 31. Because of the angle 73, the sides 81 of the hole 80 are at a complementary angle 74 to the signal conductor 22. With the hole side 81 at the complementary angle 74, the sharp edge 82 of the hole side 81 digs into and grabs and captures the conductor 22 in the hole 80. The coupling 38 cannot be removed without bending the coupling 38.

Optionally, the joint can be bonded by solder, adhesive, or other appropriate means.

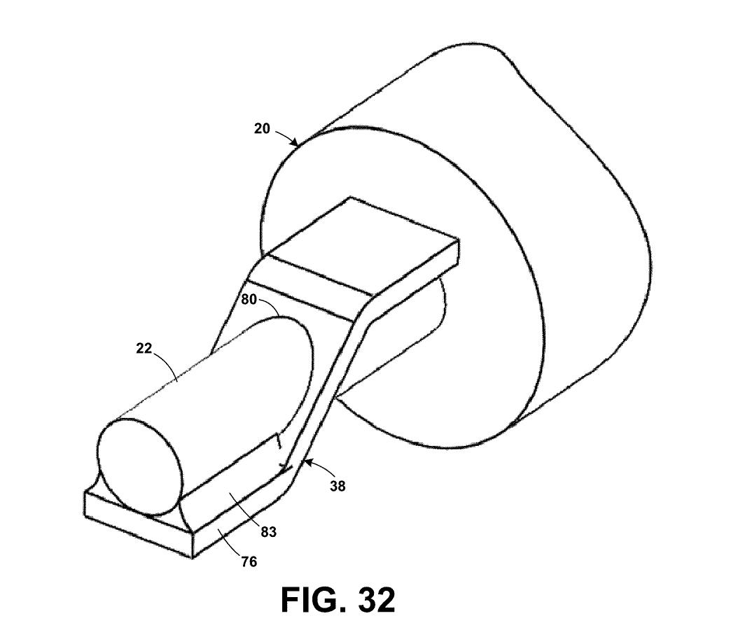

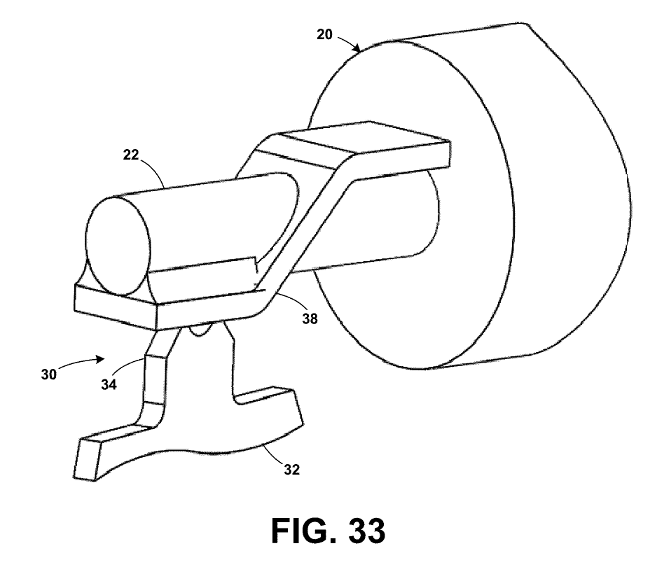

The end sections 75, 76 of the coupling 38 extend generally parallel to the signal conductor 22. FIG. 32 shows the coupling 38 attached to the signal conductor 22 with a solder or adhesive fillet 83 on an end section 76. FIG. 33 shows the contact cable end 34 attached to the coupling 38 to form the signal contact assembly 30.

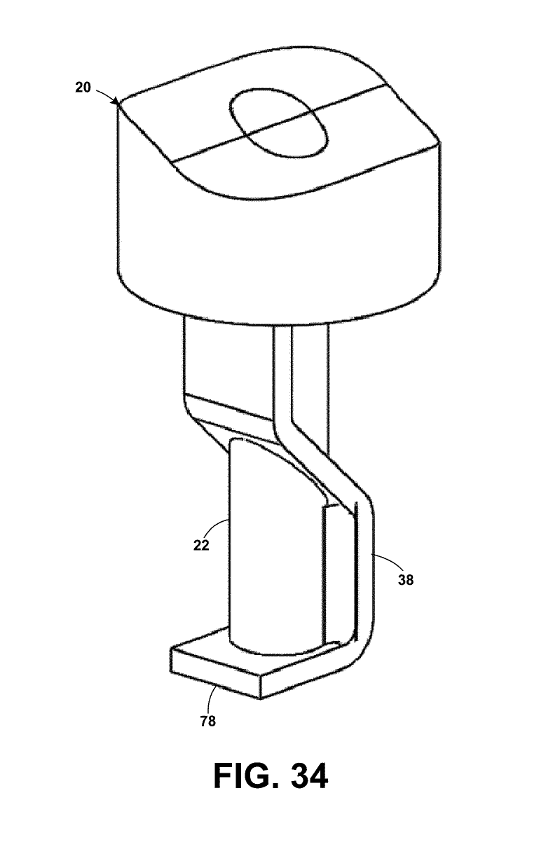

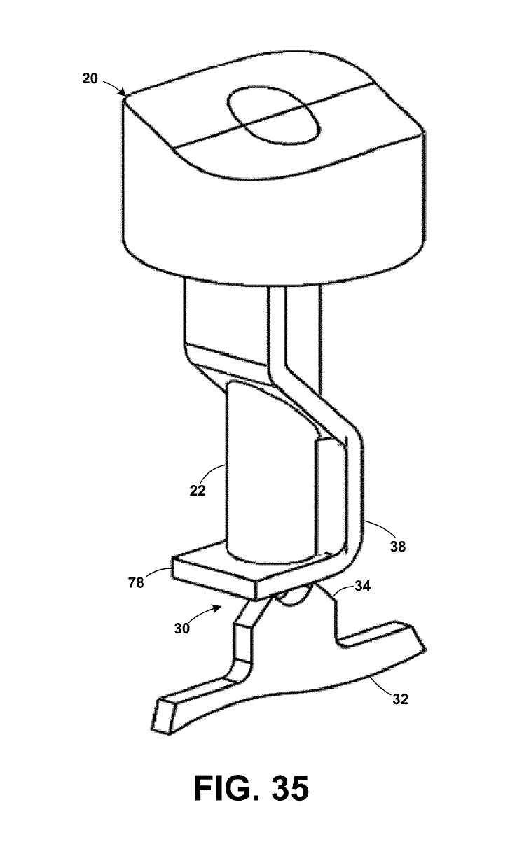

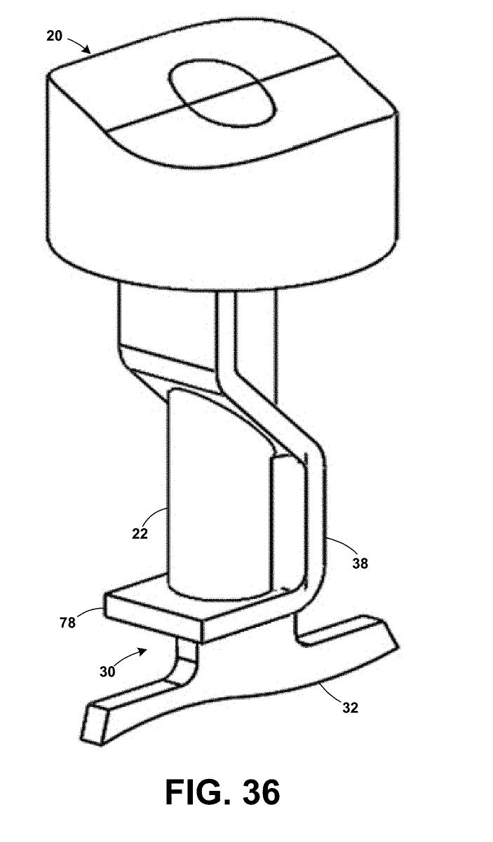

FIG. 34 shows the coupling 38 with an extra 90° bend forming a cap 78 that extends over the end of the signal conductor 22. FIG. 35 shows the contact cable end 34 permanently attached to the coupling cap 78 to form the signal contact assembly 30 such that the signal contact 32 is longitudinally-aligned with the signal conductor 22. Alternatively, the coupling 38 is formed as one end of the signal contact 32, as in FIG. 36. Both configurations of the signal contact assembly 30 are contemplated by the present invention. In either case, the coupling 38 is considered by the present invention to be an element of the signal contact assembly 30.

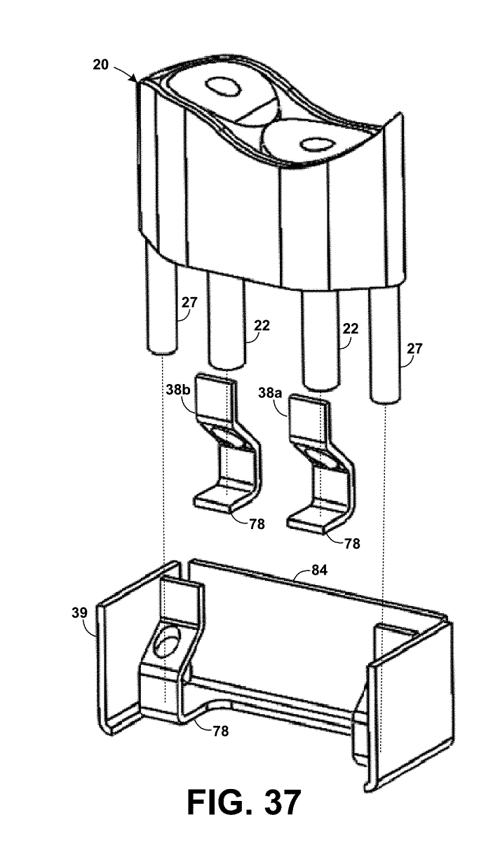

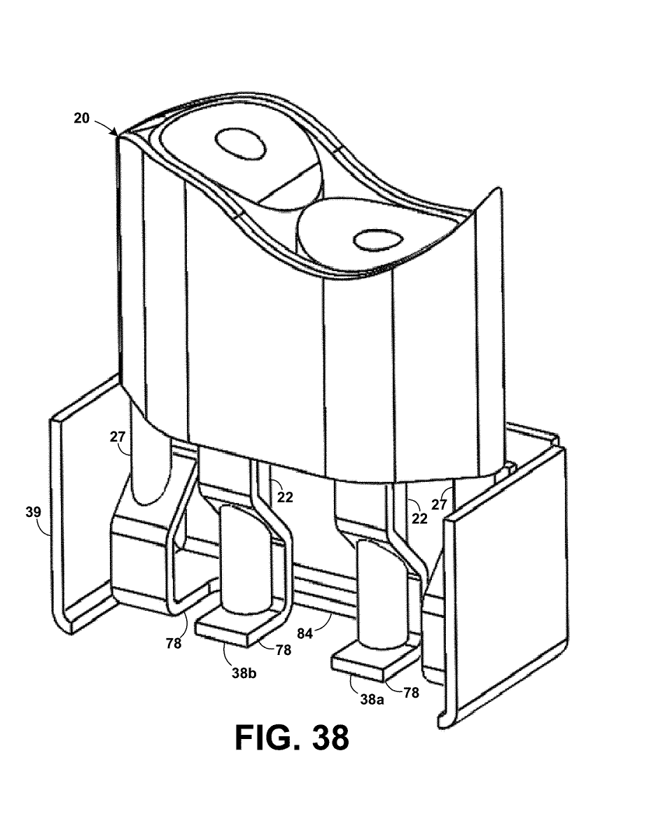

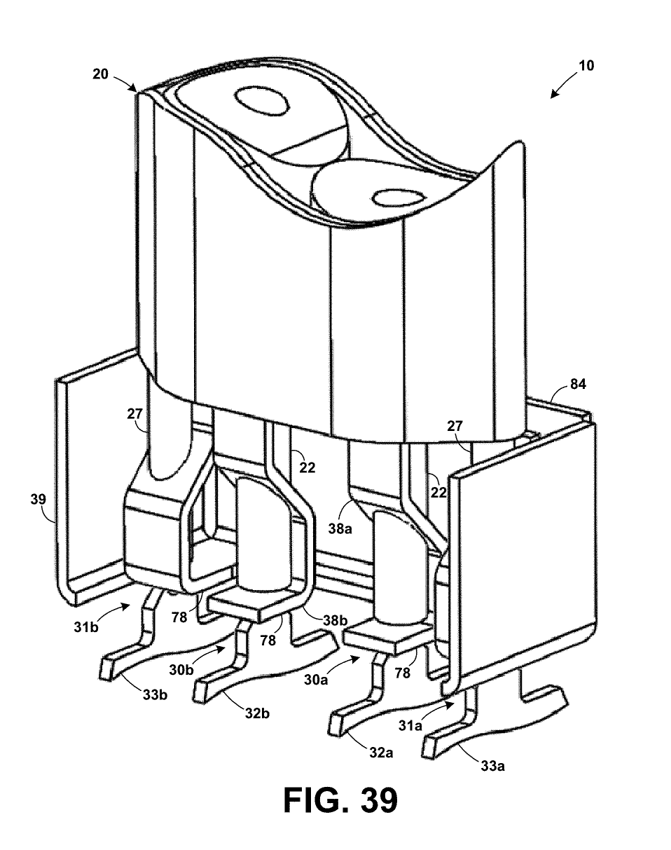

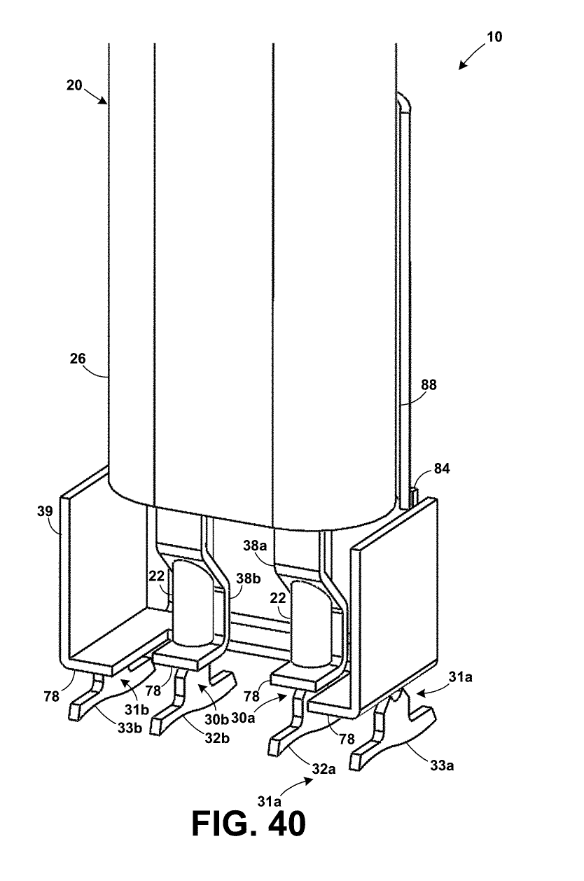

FIGS. 37-41 show the coupling 38 of FIG. 34 extended to a twinaxial cable. FIG. 37 is an exploded view showing three couplings 38a, 38b, 39 and the dressed end of a twinaxial cable 20. Two of the couplings 38a, 38b are the couplings 38 of FIG. 34 and are for the two signal conductors 22. The third coupling 39 is for attaching to the cable shield 26 via the drain wires 27 and is essentially two couplings 38 attached by a conductive bridge 84 at the end caps 78. The bridge 84 bypasses the signal conductor couplings 38a, 38b without making contact with the signal conductor couplings 38a, 38b. FIG. 38 shows the couplings 38a, 38b attached to the signal conductors 22 and the bridged coupling 39 attached to the drain wires 27. FIG. 39 shows the assembly with signal contact cable ends 34 attached to the coupling caps 78 and ground contact cable ends 36 attached to the bridged coupling caps 78, where the contacts 32, 33 extend longitudinally from the signal conductors 22 and drain wires 27.

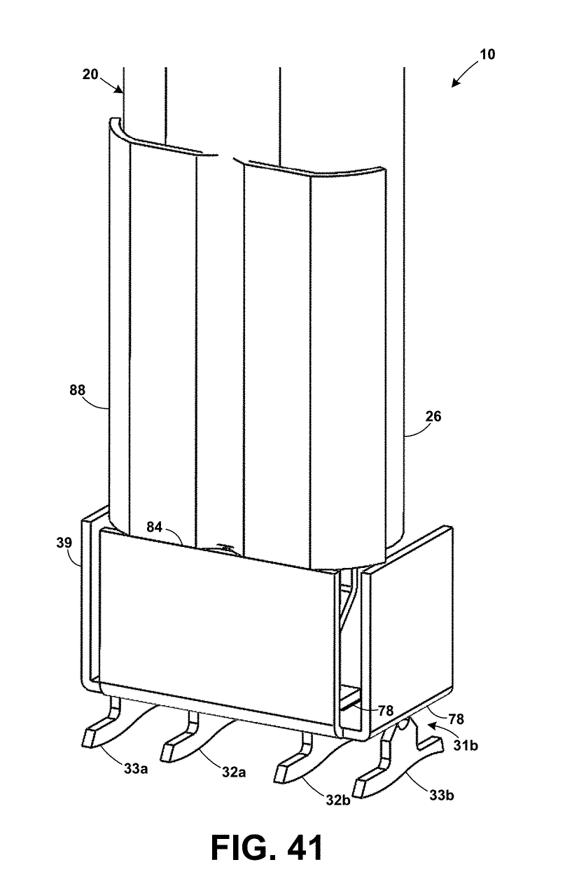

FIGS. 40 and 41 show the couplings 38a, 38b crimped to the signal conductors 22 and a bridged coupling 39 clamped to the cable shield 26 without drain wires 27, as at 88. The signal contact cable ends 34 are attached to the coupling caps 78 and the ground contact cable ends 36 are attached to the caps 78 of bridged coupling 39.

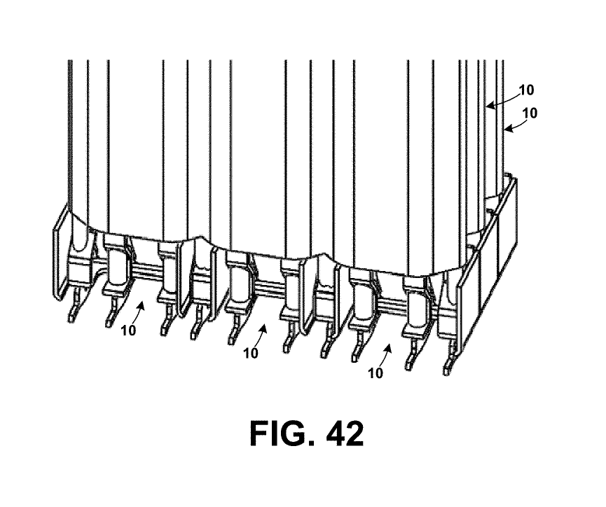

FIG. 42 shows nine of the termination assemblies 10 of FIG. 39 arrayed in a 3×3 matrix. One result of longitudinally aligning the contacts 32, 33 with the signal conductors 22 and drain wires 27 is the ability to create dense arrays like that shown in FIG. 42.

Thus it has been shown and described a compliant cable termination. Since certain changes may be made in the present disclosure without departing from the scope of the present invention, it is intended that all matter described in the foregoing specification and shown in the accompanying drawings be interpreted as illustrative and not in a limiting sense.

1. A controlled-impedance cable termination for a controlled-impedance cable, the cable comprising at least one signal conductor, a dielectric surrounding the at least one signal conductor, and a ground shield surrounding the dielectric, the termination comprising a compliant signal contact assembly permanently attached to the signal conductor.

2. The controlled-impedance cable termination of claim 1 wherein the compliant signal contact assembly is a compliant signal contact.

3. The controlled-impedance cable termination of claim 1 wherein the compliant signal contact assembly is comprised of a signal coupling permanently attached to the signal conductor and a separate compliant signal contact permanently attached to the signal coupling.

4. The controlled-impedance cable termination of claim 3 wherein the signal coupling is crimped to the signal conductor.

5. The controlled-impedance cable termination of claim 3 wherein the signal coupling is a generally S-shaped component with a center section and two end sections, the center section having a hole through which the signal conductor extends at a non-90° angle to the signal conductor and wherein the angle causes the hole edge to capture the conductor, the end sections being generally parallel to the signal conductor.

6. The controlled-impedance cable termination of claim 1 further comprising a compliant ground contact assembly permanently attached to the shield.

7. The controlled-impedance cable termination of claim 6 wherein the compliant ground contact assembly is a compliant ground contact.

8. The controlled-impedance cable termination of claim 6 wherein the shield includes at least one drain wire and the compliant ground contact assembly is comprised of a ground coupling permanently attached to the drain wire and a separate compliant ground contact permanently attached to the ground coupling.

9. The controlled-impedance cable termination of claim 1 further comprising a non-conductive anchor block having a through aperture for the compliant signal contact assembly.
